(19) United States
(12) Patent Application Publication
(10) Pub. No.: US 2004/0022720 A1
(43) Pub. Date: Feb. 5, 2004

(54) Hydrogen halide separation

(76) Inventors: Robert Elliott Low, Northwich (GB); John Charles McCarthy, Warrington (GB); Lee Colin Draper, Hawarden (GB)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/415,697

(22) PCT Filed: Nov. 30, 2001
(86) PCT No.: PCT/GB01/05302

(30) Foreign Application Priority Data
Nov. 30, 2000 (GB) 0029208.6

(51) Int. Cl. C01B 7/07

(52) U.S. Cl. 423/488; 423/240 R

(57) ABSTRACT

A process for separating a hydrogen halide from a mixture comprising one or more organic compounds and a hydrogen halide, which process comprises the steps of (1) contacting said mixture with an amine hydrohalide solvent and (2) separating the one or more organic compounds from the amine hydrohalide solvent.

This invention relates to a process for separating a hydrogen halide from a mixture comprising one or more halogenated organic compounds and one or more hydrogen halides. The hydrogen halides that can be separated using the process of this invention include hydrogen fluoride and hydrogen chloride. The process of the invention is particularly useful for the separation of hydrogen fluoride from a mixture comprising one or more halogenated organic compounds especially from mixtures comprising fluorine containing organic compounds.

Fluorine-containing organic compounds (i.e. fluorocarbons) such as (hydro)fluorocarbons (HFCs), (hydro)chlorofluorocarbons (HCFCs) and chlorofluorocarbons (CFCs) are widely used in refrigeration, foam blowing and propellant applications.

Such fluorine-containing compounds are often produced by reacting a halocarbon starting material containing one or more atoms other than fluorine, especially chlorine atoms, with hydrogen fluoride in the liquid or gaseous phase in the presence of a fluorination catalyst. Such reactions typically produce the desired fluorine-containing organic compound as well as organic by-products, a hydrogen halide such as hydrogen chloride and unreacted hydrogen fluoride and other starting materials. It is desirable to separate these products and to recover as much as possible of the hydrogen fluoride for re-use.

A proportion of the hydrogen fluoride can usually be separated and recovered by distillation but the resulting distillate usually contains residual hydrogen fluoride, especially in cases where the organic products and hydrogen fluoride form an azeotrope. This residual hydrogen fluoride is usually removed from the organic compound(s) by scrubbing the product stream with water or preferably aqueous alkali. Simple distillation techniques do not, therefore, adequately separate hydrogen fluoride from the desired products to provide pure hydrogen fluoride and fluorocarbon product streams.

Other methods of separating hydrogen fluoride from fluorine-containing organic products are known.

WO97/49656 describes the recovery of 1,1,1,3,3-pentafluoropropane (R-245fa) from a mixture comprising R-245fa and HF. The process described in WO97/49656 comprises contacting at least one extraction agent selected from (a) a compound of formula CₓF_{y}H_{z} wherein 3<x<10, 2<y<22 and 0<z<6 (b) a compound of formula R₁R₂R₃N wherein R₁, R₂ and R₃ are fluoroalkyl groups each having from 1 to 10 carbon atoms and having no more than 2 hydrogen atoms, (c) a compound of formula R₄OR₅ wherein R₄ and R₅ are alkyl groups each having from 1 to 10 carbon atoms and at least one of R₄ and R₅ contain one fluorine atom and a compound of formula CₗClₘHₙ wherein 1 is an integer of from 3 to 10, m is an integer of from 2 to 22 and n is an integer of from 0 to 6 with a mixture comprising R-245fa and hydrogen fluoride. A liquid mixture is formed and separated into two liquid layers. An extraction agent phase comprising the extraction agent and R-245fa as the main components is obtained. R-245fa is recovered from the extraction layer. The partition coefficient of this process is relatively low and a multi-stage process for the recovery and reconstitution of the products is required.

JP-A-9110738 discloses a method for separating 1,1,1,2-tetrafluoroethane (R-134a) from a mixture comprising R-134a and hydrogen fluoride. The method comprises contacting the mixture with an organic extractant, such as a compound of general formula CₓF_{y}H_{z} wherein 3<x<10, 3<y<33 and 0<z<6, R¹R²R³N wherein R¹, R² and R³ are each an alkyl group having from 1 to 10 carbon atoms and at least one of R¹, R² and R³ comprises at least one fluorine atom or R⁴OR⁵, to liquefy the mixture and then separating the mixture to provide an extractant phase containing R-134a and extractant. The R-134a is then separated from the extractant. The method of JP-A-9110738 is characterised by the mutual solubility of the organic fluorine containing compound with 134a and a low mutual solubility with HF, thereby providing a means for 134a/HF separation.

JP-A-61158801 discloses a process for separating hydrogen fluoride from a mixture comprising hydrogen fluoride and a compound having a boiling point that is close to that of hydrogen fluoride and a mutual solubility for HF such as a sulfur or oxygen containing organic compound. Preferably, the organic compound contains oxygen. The process comprises adding an amine to the mixture and then distilling the mixture to separate the hydrogen fluoride from the compound having a boiling point that is close to that of hydrogen fluoride.

Stenström et al. (Can. J. Chem. Eng., 66, 1988, 249-257 and Can. J. Chem. Eng., 64, 1986, 426-431) and Moore (Analytical Chemistry, 29, 1957, 11, 1660-1662) disclose the use of long chain amines as extractants for organic acids from dilute aqueous solutions. The method can be used with acids such as phosphoric, hydrochloric, sulphuric, hydrofluorosilicic and hydrofluoric acid. When the methods described in these articles are used to extract hydrogen fluoride, the conditions used result in low molar ratios of hydrogen fluoride in the amine phase and recovery of hydrogen fluoride is problematic.

It is an object of the present invention to provide a process for the extraction of a hydrogen halide, particularly hydrogen fluoride, which provides the hydrogen halide in a form that is suitable for recycling without the need for a costly distillation step and, preferably, without washing with water.

The present invention provides a new process for separating a hydrogen halide from a mixture comprising one or more halogenated organic compounds and a hydrogen halide. The process of the invention is particularly useful for separating hydrogen fluoride from fluorine containing organic compounds.

The process of the invention comprises the steps of (1) contacting a mixture comprising one or more halogenated organic compounds and a hydrogen halide with an amine hydrohalide solvent such as an amine hydrofluoride solvent and (2) separating the one or more halogenated organic compounds from the amine hydrohalide solvent.

The amine hydrohalide may be, for example, an amine hydrofluoride or an amine hydrochloride. Mixtures of amine hydrohalides, such as a mixture of an amine hydrofluoride and an amine hydrochloride may be used. The use of an amine hydrofluoride is particularly preferred.

It is possible to regenerate the amine hydrohalide solvent for re-use.

The solutions of the present invention can be handled and processed in apparatus made from conventional materials. This, in addition to the fact that the partition coefficient of the reaction of the invention is high, means that the process of the invention is more economically viable than many of the processes currently in use.

The amines that are suitable for use in the process of the present invention are amines which are capable of forming an amine hydrohalide solvent (ie, amines that have a greater affinity to hydrogen fluoride than to the organic compound). Amines suitable for use to form the amine hydrohalide solvents used in the process of the present invention include those of the formula:

R¹R²R³N

wherein R¹, R² and R³ are each independently hydrogen, unsubstituted C₁-C₃₀ branched or linear alkyl, unsubstituted C₁-C₃₀ branched or linear alkenyl, or any two of R¹, R² and R³, together with the nitrogen atom to which they are attached form an unsubstituted heterocycle, and no more than two of R¹, R² and R³ are hydrogen.

When any one of R¹, R² and R³ is an alkyl group or an alkenyl group these groups each preferably comprise from 1 to 15 carbon atoms, more preferably from 1 to 9 carbon atoms. When two of R¹, R² and R³, together with the nitrogen atom to which they are attached, form a heterocyclic group the heterocyclic group may be saturated or unsaturated, it may, for example, be an aryl group. The heterocyclic group typically contains from 4 to 7 atoms in the ring, preferably 5 or 6.

Preferably the amine is a secondary or tertiary amine. Tertiary amines are particularly preferred, as they tend to be less flammable and/or volatile.

Preferred amines include tributylamine, tri-isoctylamine, tri-nonylamine, tri-decylamine, pyridine, methylpyridine, dimethylpyridine and ethylpyridine.

The amine, together with the hydrogen halide, forms an amine hydrohalide solvent of formula:

R¹R²R³N.xHHal

wherein R¹, R² and R³ are as defined above, Hal is a halogen, for example chlorine or fluorine, preferably fluorine, and x represents the molar ratio of hydrogen halide to base amine and is typically from 1 to 15.

Preferred amine hydrohalide solvents include tributylamine hydrofluoride, tri-isooctylamine hydrofluoride, tri-nonylamine hydrofluoride, tri-decylamine hydrofluoride, pyridine hydrofluoride, methylpyridine hydrofluoride, dimethylpyridine hydrofluoride, ethylpyridine hydrofluoride, piperidine hydrofluoride, and melamine hydrofluoride.

The molar ratio of the hydrogen halide, for example hydrogen fluoride, to base amine is important in determining the properties of the amine hydrohalide solvent. Typically the molar ratio of hydrohalide (for example hydrogen fluoride) to amine in the amine hydrohalide complex is from 1:1 to 15:1, preferably from 3:1 to 8:1. At concentrations below 1:1 the viscosity of the species increases and the temperature required to remove, for example hydrogen fluoride, increases and as a result it may be necessary to construct the reaction vessel using material which are more resistant to corrosion and hence more expensive. At concentrations above 15:1 the vapour pressure of the amine hydrohalide is similar to that of the hydrogen fluoride to be absorbed so the efficiency of recovery is poor.

Amine hydrohalides are formed by the reaction of an amine with a hydrogen halide. For example amine hydrofluorides are formed by the reaction of an amine with hydrogen fluoride. Typically, the hydrogen fluoride dissolves readily in the amine to form a series of complex compounds. The amine hydrohalides, such as amine hydrofluorides, have properties that are distinctly different to those of either the hydrogen halide (for example hydrogen fluoride) or the base amine. For example, viscosity, vapour pressure, density and corrosion potential are a function of the ratio of the two components.

The amine hydrohalide solvent, for example an amine hydrofluoride solvent, absorbs the hydrogen halide, for example hydrogen fluoride, from the mixture comprising one or more halogenated organic compounds and the hydrogen halide, for example hydrogen fluoride, to provide a further amine hydrohalide species, such as a further amine hydrofluoride species. The mixture is essentially free from hydrogen halide, for example hydrogen fluoride, once the halogenated organic compound is separated from the amine hydrohalide.

Without wishing to be bound by any theory, it seems to the present inventors that amine hydrofluorides are especially suitable as hydrogen fluoride extraction solvents because they are not as corrosive and the hydrogen fluoride is easily recoverable compared to hydrogen fluoride solutions in, for example, alkali metal fluorides or water. As a result, the solutions of the present invention can be handled and processed in apparatus made from conventional materials, such as low temperature carbon steel, stainless steel or glass. In contrast, other technologies for separation of hydrogen fluoride require the use of materials such as nickel alloys, for example Monel, Inconel or Hastelloy.

The ratio of the hydrogen halide (for example, hydrogen fluoride) to be separated to the amine hydrohalide mixture (for example, amine hydrofluoride) is typically from 3:1 to 5:1, preferably from 4:1 to 5:1. About 99% hydrogen fluoride recovery can be achieved using ratios within these ranges.

The amine hydrohalide solvent may either be formed in situ or prior to the first step of the reaction.

For example, when an amine hydrofluoride solvent is formed in situ, an amine of formula R¹R²R³N, wherein R¹, R² and R³ are as defined previously, is added to the mixture comprising one or more halogenated organic compounds and hydrogen fluoride. The amine then reacts with the hydrogen fluoride in the mixture to form the desired amine hydrofluoride solvent.

When, for example, an amine hydrofluoride solvent is formed prior to the first step of the reaction, an amine of formula R¹R²R³N, wherein R¹, R² and R³ are as defined previously, is reacted with hydrogen fluoride to form the amine hydrofluoride solvent. The solvent is then added to the mixture comprising one or more halogenated organic compounds and hydrogen fluoride. The solvent is stable and can be stored prior to use.

In both cases, the amine hydrofluoride solvent reacts with the hydrogen fluoride in the mixture to produce further amine hydrofluoride products.

The one or more halogenated organic compounds which are subjected to the process of the present invention typically comprise at least one halogen atom, preferably at least one fluorine atom. Typically the halogenated organic compounds have the formula:

CₐH_{b}X_{c}

Wherein a is from 1 to 6, b is from 0 to 13, c is from 1 to 14 and X is chlorine or fluorine or a mixture of chlorine and fluorine. Preferably b is at least 1.

The halogenated organic compounds may be saturated or unsaturated linear or branched halogenated organic compounds or saturated or unsaturated halogenated cyclic organic compounds.

When the halogenated organic compounds are saturated linear or branched compounds they typically have the formula:

CₐH_{b}X_{c}

wherein a is from 1 to 6, b is from 0 to 13, c is from 1 to 14, such that b+c is 2a+2 and X is chlorine or fluorine or a mixture of chlorine and fluorine. Preferably a is from 1 to 4, b is from 0 to 9 and c is from 1 to 10, such that b+c is 2a+2. Preferably b is at least 1. For example, 1,1,1,2-tetrafluoroethane is a suitable halogenated organic compound.

When the halogenated organic compounds are halogenated linear or branched alkenes they typically have the formula:

CₐH_{b}X_{c}

wherein a is from 1 to 6, b is from 0 to 11, c is from 1 to 12, such that b+c is 2a and X is chlorine or fluorine or a mixture of chlorine and fluorine. Preferably a is from 1 to 4, b is from 0 to 7 and c is from 1 to 8, such that b+c is 2a. Preferably b is at least 1. For example, tetrafluoroethylene is a suitable halogenated organic compound.

When the halogenated organic compounds are halogenated linear or branched dialkenes they typically have the formula:

CₐH_{b}X_{c}

wherein a is from 1 to 6, b is from 0 to 9, c is from 1 to 10, such that b+c is 2a-2 and X is chlorine or fluorine or a mixture of chlorine and fluorine. Preferably a is from 1 to 4, b is from 0 to 5 and c is from 1 to 6, such that b+c is 2a-2. Preferably b is at least 1. For example, hexafluorobutadiene is a suitable halogenated organic compound.

When the halogenated organic compounds are halogenated cyclic alkanes they typically have the formula:

CₐH_{b}X_{c}

wherein a is from 3 to 6, b is from 0 to 11, c is from 1 to 12, such that b+c is 2a and X is chlorine or fluorine or a mixture of chlorine and fluorine. Preferably b is at least 1. For example, perfluorocyclobutane is a suitable halogenated organic compound.

When the halogenated organic compounds are cyclic alkenes they typically have the formula:

CₐH_{b}X_{c}

wherein a is from 3 to 6, b is from 0 to 9, c is from 1 to 10, such that b+c is 2a −2 and X is chlorine or fluorine or a mixture of chlorine and fluorine. Preferably b is at least 1. For example, perfluorocyclobutene is a suitable halogenated organic compound.

The halogenated organic compounds may comprise a mixture of any of the above mentioned types of organic compounds. For example, the halogenated organic compounds may be a mixture of saturated linear and/or branched halogenated compounds or a mixture of saturated and unsaturated compounds.

It is particularly preferred that at least one organic compound contains at least one fluorine atom. Suitable fluorine-containing compounds include (hydro)fluorocarbons, (hydro)fluorochlorocarbons and chlorofluorocarbons. It is preferable that at least one organic compound is a (hydro)fluorocarbon. Particularly preferred fluorine-containing organic compounds include 1,1,1,2-tetrafluoroethane (R-134a), difluoromethane (R-32), pentafluoroethane (R-125), chlorodifluoromethane (R-22), 1,1,1,3,3-pentafluoropropane (R-245), hexafluoropropane, hexafluorobutane (R-356), heptafluoropropane (R-227), tetrafluoroethylene, hexafluorobutadiene, perfluorocyclobutane and perfluorocyclobutene.

By the term “(hydro)fluorocarbon”, we mean a compound comprising carbon, fluorine and hydrogen atoms only. By the term “(hydro)fluorochlorocarbon”, we mean a compound comprising carbon, fluorine, chlorine and hydrogen atoms only and by the term “chlorofluorocarbon”, we mean a compound comprising carbon, fluorine and chlorine atoms only.

The mixture comprising one or more halogenated organic compounds and hydrogen fluoride is typically produced by the reaction of a halogen-containing compound containing one or more halogen atoms other than fluorine, especially chlorine atoms, with hydrogen fluoride in the liquid or gaseous phase, optionally in the presence of a fluorination catalyst. Such a reaction generally produces a mixture comprising a desired fluorine-containing organic compound and unreacted hydrogen fluoride, as well as organic by-products. Mixtures of one or more halogenated organic compounds and other hydrogen halides can be obtained in a similar manner.

Suitable halogen-containing compounds include any such compounds known in the art as being suitable for the preparation of another halogen-containing organic compound such as a fluorine-containing organic compound. For example, the halogen-containing compounds may comprise carbon and halogen atoms only or they may comprise carbon, halogen and hydrogen atoms.

Preferably, the mixture of one or more organic compounds and a hydrogen halide such as hydrogen fluoride comprises an azeotropic, or azeotrope-like mixture, or an anhydrous mixture. Mixtures comprising less than 0.5% by weight of water, preferably less than 0.05% by weight of water, more preferably less than 0.02% by weight of water are considered to be anhydrous.

By the term “azeotropic mixture” we mean a composition comprising two or more components which exhibit constant boiling behaviour and which tend not to fractionate or separate into their constituent components upon boiling or evaporation. By the term “azeotrope-like mixture” we mean a composition that behaves like a true azeotrope in that it exhibits constant boiling or essentially constant boiling behaviour and tends not to fractionate to any significant degree on boiling.

The process of the present invention is suitable for use with azeotropic mixtures of the halogenated organic compound and a hydrogen halide such as hydrogen fluoride. If the halogenated organic and the hydrogen halide form an azeotrope or an azeotropic mixture it may be preferable to separate the excess hydrogen halide from the azeotropic mixture prior to the introduction of the amine hydrohalide.

The process of the present invention can be applied to mixtures containing any amount of a hydrogen halide such as hydrogen fluoride.

The mixture comprising one or more organic compounds and a hydrogen halide such as hydrogen fluoride is typically in the liquid or vapour phase in step (1) of the process.

In the process of the invention the mixture comprising one or more halogenated organic compounds and a hydrogen halide such as hydrogen fluoride is mixed with the amine hydrohalide solvent such as an amine hydrofluoride solvent for a sufficient time so as to allow the amine hydrohalide solvent to absorb the hydrogen halide from the one or more halogenated organic compounds. The residence time is typically from 3 seconds to 1 hour, preferably from 1 minute to 15 minutes.

The apparatus suitable for use in the present invention will depend on whether the mixture comprising one or more halogenated organic compounds and the hydrogen halide (for example hydrogen fluoride) is in the liquid or vapour phase when it is contacted with the amine hydrohalide solvent (for example an amine hydrofluoride solvent).

Heat is typically evolved when the hydrogen halide is contacted with the amine hydrohalide solvent. If the mixture is in the liquid phase when it is originally contacted with the amine hydrohalide solvent, then the pressure during the reaction step may be controlled so as to encourage or inhibit the boiling of the organic compounds. The operating temperature of the process can also be regulated if the pressure is controlled and the heat of reaction between the hydrogen halide (for example hydrogen fluoride) and amine hydrohalide solvent may be absorbed.

A mixture comprising one or more halogenated organic compounds and hydrogen fluoride is typically more volatile than the amine hydrofluoride solvent.

If the mixture comprising one or more halogenated organic compounds and hydrogen fluoride is in the liquid phase (whether boiling or not) when it is contacted with the amine hydrofluoride solvent, then suitable equipment includes stirred mixing tanks, in-line static flow mixing equipment, jet mixing equipment or venturi eductors. These general equipment types can, optionally, be built as part of a heat exchanger apparatus to allow removal of heat by external cooling. It is also possible to minimise or eliminate the need for a heat exchanger, for example by the use of auto-refrigeration if the pressure of the mixture can be reduced via an orifice, valve or the like into another vessel during the first step of the process of the invention.

If the mixture comprising one or more organic compounds and hydrogen fluoride is in the vapour phase when it is contacted with the amine hydrofluoride solvent, then suitable equipment includes those types of equipment suited for liquids, as well as bubble columns, distillation columns, absorption columns and falling-film absorption equipment. The vapour-liquid contacting can also be carried out in suitable variants of these technologies adapted for heat exchange to an external coolant.

The person of skill in the art will readily appreciate which of these apparatus are suitable for use in the recovery of hydrogen halides other than hydrogen fluoride.

In the second step of the process of the invention, the one or more halogenated organic compounds are separated from the amine hydrohalide solvent. A variety of methods of separation may be employed. The preferred method will depend on a number of factors, such as the nature of the mixture being separated and the nature of the amine hydrohalide solvent. For example, when the amine hydrohalide solvent is an amine hydrofluoride solvent the relative flow rates of hydrogen fluoride, amine hydrofluoride solvent and fluid (ie, the mixture of the halogenated organic compound and hydrogen fluoride in the liquid or gas phase) is important.

If one or more of the halogenated organic compounds is present as a liquid after step (1) of the process, then a variety of separation technologies are applicable. The amine hydrohalide solvent and the one or more organic compounds may form a single liquid phase or separate into two or more liquid phases depending on the exact composition of the amine hydrohalide and the organic compounds and other factors such as temperature.

If the amine hydrohalide solvent and the one or more halogenated organic compounds form a single liquid phase, then separation by distillation is preferred.

Apparatus suitable for separation of an amine hydrofluoride solvent from one or more halogenated organic compounds by distillation includes a single stage flash, or an evaporator unit. This apparatus is suitable because the amine hydrofluoride solvents and fluorocarbon compounds typically have a large difference in volatility. The distillation may also be carried out in a conventional distillation or stripping column. If a mixture of two or more organic compounds is being separated from the amine hydrofluoride solvent, then the use of a distillation column is preferred because this will simplify the overall process. In other words, the process is simplified because the organic compounds can be separated at the same time.

If the one or more organic compounds and amine hydrofluoride form two or more liquid phases, then liquid-liquid separation may be carried out. In all cases, the difference in density between the amine hydrofluoride solvent and the organic liquid is exploited to effect the separation.

Apparatus suitable for separation of the one or more organic compounds and amine hydrofluoride by liquid-liquid separation includes a gravity settling vessel (decanter) or enhanced liquid separation equipment, such as a centrifuge or a hydrocyclone.

If one or more of the halogenated organic compounds is present as a vapour after step (1) of the process, then any one of a variety of separation techniques may be used.

Apparatus suitable for separation of the one or more organic compounds and amine hydrofluoride in which a significant fraction of the organic compound is in the form of a vapour includes a simple knock-out pot, a packed or trayed separation column or a gas-liquid hydrocyclone.

Additionally, equipment appropriate for fine droplet collection and removal may be used after the primary vapour-liquid separation unit, depending on the amine hydrohalide droplet size distribution entering the separation step. Examples of such additional equipment include candle filters, electrostatic precipitators or “spinning mop” devices.

In all cases, the choice of separation equipment can be made based on process criteria such as operating cost, capital cost, ease of fabrication and maintenance.

The one or more halogenated organic compounds separated from the amine hydrohalide solvent may contain a residual amount of hydrogen halide. In order to improve the yield of the hydrogen halide, for example hydrogen fluoride, recovered from the one or more organic compounds, the recovered organic compounds may be subsequently contacted again with the amine hydrohalide solvent. This procedure may be repeated as often as desired.

Alternatively, the one or more halogenated organic compounds separated from the amine hydrohalide solvent may be subjected to further processes. For example, the one or more halogenated organic compounds may be separated from one another by distillation. One or more of the separated halogenated organic compounds may then be fed to an upstream point in the process, such as a reactor in which the one or more separated halogenated organic compounds are required for further reaction.

The process of the present invention may further comprise the step (3) of recovering the hydrogen halide, for example hydrogen fluoride, from the amine hydrohalide solvent, for example an amine hydrofluoride solvent, after step (2). This also regenerates the amine solvent. Typically only the hydrogen halide which has been removed from the mixture with the halogenated organic compounds is removed so that the amine hydrohalide solvent is regenerated. The amine hydrohalide may then be recycled to effect further separation.

Hydrogen fluoride may be recovered from the amine hydrofluoride solvent by heating the amine hydrofluoride solvent to vaporise the hydrogen fluoride. For example, heating to 80° C. at 2.72 barg will reconstitute a 5:1 to a 4:1 mixture of hydrogen fluoride and amine hydrofluoride. The amine hydrofluoride solvent may, optionally, be heated under reduced pressure. This method of recovery provides anhydrous hydrogen fluoride. The anhydrous hydrogen fluoride that is recovered can be collected for use in another process or recycled to an upstream process step, for example the reactor in which the organic compound is produced or a suitable feed stock line in the process. The separation and recovery of anhydrous hydrogen fluoride is preferred as anhydrous hydrogen fluoride is useful in a large number of catalytic processes.

It is possible to remove the recovered hydrogen fluoride from the amine hydrofluoride solvent by boiling the solvent because the vapour pressure of hydrogen fluoride in equilibrium with a given amine hydrofluoride solvent increases as temperature increases.

The vaporisation of hydrogen fluoride may be carried out in any standard design of evaporator, for example a vertical bayonet tube vaporiser, a falling film heat exchanger or a kettle boiler.

The vaporisation of hydrogen fluoride can be carried out in one or more stages. The number of stages that is suitable depends on the ratio of hydrogen fluoride in the amine hydrofluoride entering and leaving the regeneration step. The use of more than one stage limits the temperature variation over any vaporisation unit and avoids potential problems due to critical temperature differences between the heat source and the vaporising hydrogen fluoride solution.

The hydrogen fluoride may, alternatively, be recovered from the amine hydrofluoride solvent by washing the amine hydrofluoride solvent with water. This method of recovery provides an aqueous solution of hydrogen fluoride. The aqueous solution of hydrogen fluoride that is recovered can be collected for reuse or as a crude product.

The amine hydrofluoride solvent that remains when the hydrogen fluoride has been recovered in step (3) of the process may comprise a small amount of one or more dissolved organic compounds. The solubility of the one or more organic compounds in the amine depends on the nature of the organic compounds, the nature of the amine and the ratio of amine:hydrogen fluoride at any given temperature and pressure.

There is, typically, a large difference in volatility between the organic compound, for example a fluorocarbon, and hydrogen fluoride. Any organic compound dissolved in the amine will typically vaporise much more readily than hydrogen fluoride. The organic compound may, therefore, be separated from the amine by selective and careful control of the system pressure and the method of heat addition to the amine.

The hydrogen fluoride that is separated from the amine hydrofluoride solvent in step (3) of the process may contain a small amount of one or more organic compounds. The organic compound(s) may be separated from hydrogen fluoride by passing the hydrogen fluoride/organic stream through a condensation unit. Most of the hydrogen fluoride can be condensed if the operating conditions of the system are selected so that the flow of the organic compounds is sufficiently small compared to that of the hydrogen fluoride. The organic compound(s) separated from the hydrogen fluoride can either be recycled or destroyed.

It is possible to minimise the quantity of organic compounds that leaves the vaporiser unit with the hydrogen fluoride by reducing the pressure of the amine hydrofluoride solvent. For example, the amine hydrofluoride solvent may be passed through a restrictor orifice or valve to a gas-liquid separation vessel, so that a proportion of the total dissolved organic compounds is liberated as a gas before any appreciable quantity of hydrogen fluoride is released.

The person of skill in the art will appreciate how the methods and processes discussed above in relation to hydrogen fluoride could be adapted for use with other hydrogen halides such as hydrogen chloride.

In a further aspect, the process of the present invention can be used to recover hydrogen fluoride from a process in which an organic compound is fluorinated by hydrogen fluoride in the presence of an amine hydrofluoride catalyst. Amine hydrofluorides which are used as catalysts-in fluorinating reactions are known as Olah's reagents. It has been found by the present applicant that the amine hydrofluorides used in these fluorination reactions can also be used to separate unreacted hydrogen fluoride from the organic components and unreacted hydrogen fluoride can thus be recovered. Using the process of the present invention hydrogen fluoride can easily be recovered from a process employing an Olah's reagent. Both the fluorination reaction and the step of recovering the hydrogen fluoride may be performed in a single reaction vessel. Alternatively, the hydrogen fluoride recovery step may be performed in a separate stage.

In other words, when applied to reactions involving the use of an Olah's reaction, the present invention provides a process wherein both the reaction and primary product/feedstock separation from hydrogen fluoride may be carried out in a single process. This offers the advantage of significantly simplifying the complexity and cost of the manufacturing process.

In the processes of the invention, the mixture comprising one or more organic compounds and hydrogen fluoride may, optionally, be treated prior to contact with the amine hydrofluoride solvent. For example, the mixture may be treated to remove compounds other than the desired fluorine-containing organic compound from the mixture by distillation or phase separation.

The processes of the invention may be operated as batch processes, but it is preferable to operate the processes of the invention as continuous processes.

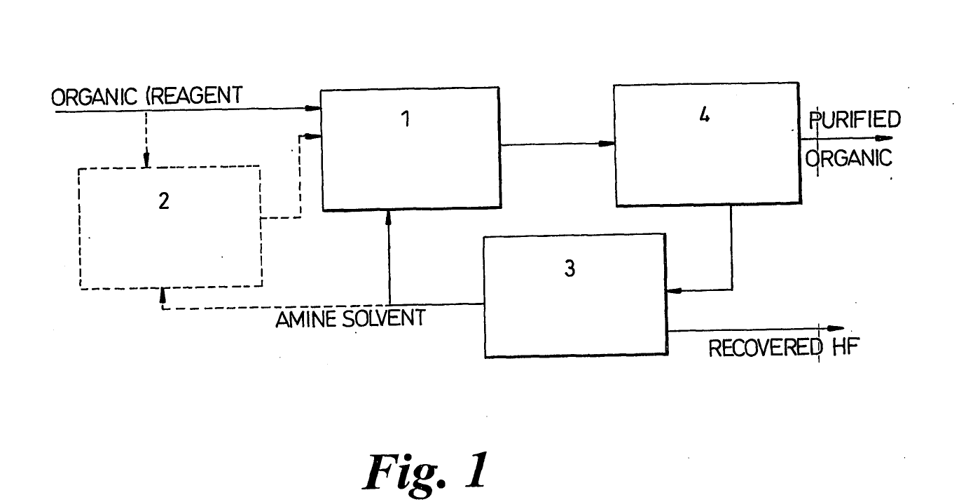

The process of an embodiment of the invention will now be illustrated with reference to the accompanying drawing FIG. 1, which is a schematic representation of a plant for carrying out the process.

A mixture comprising one or more organic compounds and hydrogen fluoride and an amine or amine hydrofluoride solvent are introduced to a mixing stage 1. The mixture comprising one or more organic compounds and hydrogen fluoride can be added directly to the mixing stage 1 or via a reaction stage 2. The amine or amine hydrofluoride solvent is preferably added to the mixing stage 1 via a regeneration stage 3, but may, optionally, be added directly to the mixing stage. In the mixing stage 1, the mixture comprising one or more organic compounds and hydrogen fluoride and the amine or amine hydrofluoride solvent are mixed for a sufficient time so as to allow the amine or amine hydrofluoride solvent to absorb the hydrogen fluoride from the mixture of one or more organic compounds and hydrogen fluoride. As a result, further amine hydrofluoride solvents are produced. The mixture that results exits the mixing stage 1 and is fed into a separation stage 4. In the separation stage 4, the mixture comprising one or more organic compounds is separated from the amine hydrofluoride solvent. The purified mixture comprising one or more organic compounds exits the separation stage 4 and may then be fed to an upstream point in the process (not shown). The amine hydrofluoride solvent is fed into the regeneration stage 3, where the hydrogen fluoride and the amine or amine hydrofluoride solvent are separated. The recovered hydrogen fluoride exits the regeneration stage 4 and the amine or amine hydrofluoride solvent is, preferably, recycled to the mixing stage 1.

The present invention is now illustrated but not limited with reference to the following examples.

### EXAMPLE 1

### Use of Tributylamine and Hydrogen Fluoride:Tributylamine Complexes for the Recovery of Hydrogen Fluoride from 1,1,1,2-tetrafluoroethane (R-134a)

A known mass of tributylamine was placed in a 150 cm³ stainless steel whitey bomb. The whitey bomb was then cooled in liquid nitrogen to enable the transfer of a known mass of R-134a/hydrogen fluoride mixture. The R-134a/hydrogen fluoride mixture was pre-prepared on a scale to allow ten experiments to be conducted with the same levels of hydrogen fluoride in the R-134a. The hydrogen fluoride concentration was 3.31% w/w for the first eleven experiments and 2.94% w/w for the last four experiments.

Once the R-134a/hydrogen fluoride mixture was transferred to the whitey bomb, it was sealed and allowed to warm to ambient temperature (i.e. 22° C.). The whitey bomb was shaken for one minute to fully contact the amine with the R-134a/hydrogen fluoride mixture and was then allowed to settle for 15 minutes.

The R-134a was then vented from the whitey bomb while the amine hydrofluoride solvent remained in the bomb. The R-134a was vented through a series of water scrubbers to capture any hydrogen fluoride remaining in mixture with the R-134a. The water scrubber liquors were then bulked together and an analysis for fluoride content carried out using an ion selective electrode. Any hydrogen fluoride left within the vented R-134a was then calculated, from which the efficiency of hydrogen fluoride removal was determined.

The experiments were scaled such that the molar ratio of amine to hydrogen fluoride decreased from 1:0 to 1:15. Hydrogen fluoride analysis was carried out over this range (see Table 1—Efficiency of HF removal (2)).

Upon analysis of the first set of experimental data it was decided to carry out a second set of experiments to give more definition to the work around the area of amine:hydrogen fluoride ratio of from 1:5 to 1:9 (see Table 1—Efficiency of HF removal (3)).

TABLE 1
Results of Tributylamine/hydrogen fluoride/R-134a Study

| | Cumulative | Efficiency of HF | Efficiency of HF |
|---|---|---|---|
| | amine:HF ratio | removal (2) | removal (3) |
| Experiment | (1:x) | (%) | (%) |
| 1 | 1 | 99.7 | |
| 3 | 3 | 99.8 | |
| 5 | 5 | 99.3 | |
| 6 | 6 | | 93.37 |
| 7 | 7 | | 87.82 |
| 8 | 8 | | 79.8 |
| 9 | 9 | 50.4 | 69.41 |
| 10 | 10 | 42 | |
| 12 | 12 | 16.4 | |
| 14 | 14 | 15.8 | |
| 15 | 15 | 0 | |

The efficiency of hydrogen fluoride removal from the R-134a/hydrogen fluoride mixture decreases to around 42% w/w when the amine to hydrogen fluoride molar ratio is decreased from 1:1 to 1:10. Hydrogen fluoride removal from a R-134a/hydrogen fluoride mixture ceases when the amine:hydrogen fluoride ratio reaches 1:15.

Examples 2 to 4 illustrate the use of amine hydrohalides to recover hydrogen fluoride from mixtures of other halocarbons and hydrogen fluoride. Each of these Examples followed the procedure set out above for Example 1.

### EXAMPLE 2

### Use of Tributylamine and Hydrogen Fluoride:Tributylamine Complexes for the Recovery of Hydrogen Fluoride from R-22

TABLE 2
Results of Tributylamine/Hydrogen/R-22 Study

| | Cumulative amine:HF | Efficiency of HF |
|---|---|---|
| Experiment | ratio (1:x) | removal (%) |
| 1 | 0.94 | 99.2 |
| 5 | 4.84 | 98.04 |
| 8 | 7.77 | 80.27 |

At a ratio of 1:8 amine to hydrogen fluoride, the efficiency of hydrogen fluoride pick up by the amine is 80%. The efficiency of the process reduced with increased hydrogen fluoride concentration relative to the amine hydrofluoride.

### EXAMPLE 3

### Use of Tributylamine and Hydrogen Fluoride:Tributylamine Complexes for the Recovery of Hydrogen Fluoride From Difluoromethane (R-32) and Pentafluoroethane (R-125)

TABLE 3
Results of Tributylamine/Hydrogen fluoride/R-32 Study

| | Cumulative amine:HF | Efficiency of HF |
|---|---|---|
| Experiment | ratio (1:x) | removal (%) |
| 1 | 0.94 | 99.16 |
| 5 | 4.96 | 98.64 |
| 8 | 7.77 | 83.71 |

TABLE 4
Results of Tributylamine/Hydrogen fluoride/R-125 Study

| | Cumulative amine:HF | Efficiency of HF |
|---|---|---|
| Experiment | ratio (1:x) | removal (%) |
| 1 | 0.76 | 97.6 |
| 5 | 4.2 | 98.1 |
| 8 | 6.2 | 95.72 |
| 9 | 7.11 | 92 |

The experiments for R-32 show that the efficiency of hydrogen fluoride removal from the organic is above 80% for a hydrogen fluoride:amine ratio of 7.77:1. The efficiency of the process reduced with increased hydrogen fluoride concentration relative to the amine hydrofluoride.

The experiments for R-125 show that the efficiency of hydrogen fluoride removal from the organic is above 90% for a hydrogen fluoride:amine ratio of 7.11:1. The efficiency of the process reduced with increased hydrogen fluoride concentration relative to the amine hydrofluoride.

### EXAMPLE 4

### Use of Pyridine and Hydrogen Fluoride:Pyridine Complexes for the Recovery of Hydrogen Fluoride From 1,1,1,2-tetrafluoroethane (R-134a)

TABLE 5
Results of Pyridine/Hydrogen fluoride/R-134a Study

| | Cumulative amine:HF | Efficiency of HF |
|---|---|---|
| Experiment | ratio (1:x) | removal (%) |
| 1 | 1.41 | 98.76 |
| 2 | 2.82 | 99.53 |
| 4 | 5.8 | 96.51 |
| 5 | 7.07 | 92.39 |

The hydrogen fluoride recovery from R-134a given by pyridine is comparable to tributylamine.

1. A process for separating a hydrogen halide from a mixture comprising one or more halogenated organic compounds and a hydrogen halide, which process comprises the steps of:
(1) contacting said mixture with an amine hydrohalide solvent; and
(2) separating the one or more organic compounds from the amine hydrohalide solvent.

2. A process according to claim 1, wherein the hydrogen halide is hydrogen fluoride and/or the amine hydrohalide solvent is an amine hydrofluoride solvent.

3. A process according to claim 1 or 2, wherein the amine of the hydrofluoride solvent has the formula:
R¹R²R³N
wherein R¹, R¹ and R³ are each independently hydrogen, unsubstituted C₁-C₃₀ branched or linear alkyl, unsubstituted C₁-C₃₀ branched or linear alkenyl, or any two of R¹, R² and R³, together with the nitrogen atom to which they are attached, form an unsubstituted heterocycle, and no more than two of R¹, R² and R³ are hydrogen.

4. A process according to claim 3, wherein any two of R¹, R² and R³, together with the nitrogen atom to which they are attached, form a heterocyclic ring.

5. A process according to claim 3 or 4 wherein the amine hydrohalide solvent has the formula:
R₁R²R³N.xHHal
wherein R¹, R² and R³ are as defined in claim 3 or 4, Hal is a halogen and x represents the molar ratio of hydrogen halide to base amine and is from 1 to 15.

6. A process according to any one of the preceding claims, wherein the amine hydrohalide solvent is tributylamine hydrofluoride, tri-isooctylamine hydrofluoride, tri-nonylamine hydrofluoride, tri-decylamine hydrofluoride, pyridine hydrofluoride, methylpyridine hydrofluoride, dimethylpyridine hydrofluoride, ethylpyridine hydrofluoride, piperidine hydrofluoride, or melamine hydrofluoride.

7. A process according to any one of the preceding claims, wherein in step (1) an amine is contacted with said mixture to form the amine hydrofluoride solvent in situ.

8. A process according to any one of claims 1 to 6, wherein the amine hydrofluoride solvent is formed prior to the first step of the process.

9. A process according to any one of the preceding claims, wherein the halogen-containing organic compound or compounds have the formula:
CₐH_{b}X_{c}
wherein a is from 1 to 6, b is from 0 to 13, c is from 1 to 14 and X is chlorine or fluorine or a mixture of chlorine and fluorine.

10. A process according to claim 9, wherein the halogenated organic compounds are selected from (hydro)fluorocarbons, chlorofluorocarbons and (hydro)chlorofluorocarbons and mixtures thereof.

11. A process according to claim 9, wherein the or at least one halogen-containing organic compound is a linear or branched compound having the formula:
CₐH_{b}X_{c}
wherein a is from 1 to 4, b is from 0 to 9 and c is from 1 to 10, such that b+c is 2a+2.

12. A process according to claim 9, wherein the or at least one halogen-containing organic compound is a linear or branched compound having the formula:
CₐH_{b}X_{c}
wherein a is from 1 to 4, b is from 0 to 7 and c is from 1 to 8, such that b+c is 2a.

13. A process according to claim 9, wherein the or at least one halogen-containing organic compound is a linear or branched compound having the formula:
CₐH_{b}X_{c}
wherein a is from 1 to 4, b is from 0 to 5 and c is from 1 to 6, such that b+c is 2a-2.

14. A process according to claim 9, wherein the or at least one halogen-containing organic compound is a cyclic compound having the formula:
CₐH_{b}X_{c}
wherein a is from 3 to 6, b is from 0 to 11 and c is from 1 to 12, such that b+c is 2a.

15. A process according to claim 9, wherein the or at least one halogen-containing organic compound is a cyclic compound having the formula:
CₐH_{b}X_{c}
wherein a is from 3 to 6, b is from 0 to 9 and c is from 1 to 10, such that b+c is 2a-2.

16. A process according to claim 10, wherein the or at least one of the halogenated organic compounds is 1,1,1,2-tetrafluoroethane (R-134a), difluoromethane (R-32), pentafluoroethane (R-125), chlorodifluoromethane (R-22), 1,1,1,3,3-pentafluoropropane (R-245), hexafluoropropane, hexafluorobutane (R-356), heptafluoropropane (R-227), tetrafluoroethylene, hexafluorobutadiene, perfluorocyclobutane or perfluorocyclobutene.

17. A process according to any one of claims 2 to 16, wherein the mixture comprising one or more halogenated organic compounds and hydrogen fluoride is produced by the reaction of a halogen-containing compound comprising one or more halogen atoms other than fluorine with hydrogen fluoride in the liquid or gaseous phase, optionally in the presence of a fluorination catalyst.

18. A process according to any one of the preceding claims, wherein the mixture of one or more organic compounds and a hydrogen halide is an azeotropic or azeotope-like mixture and/or an anhydrous mixture.

19 A process according to any one of the preceding claims, wherein in step (1) said mixture is in the liquid or a vapour phase.

20. A process according to any one of the preceding claims, wherein in step (2) the organic compounds are separated from the amine hydrohalide solvent by distillation or liquid-liquid separation.

21. A process according to any one of the preceding claims, further comprising the step (3) of recovering the hydrogen halide from the amine hydrohalide solvent after step (2).

22. A process according to claim 21, wherein hydrogen fluoride is recovered from the amine hydrofluoride solvent by heating the amine hydrofluoride solvent to vaporise the hydrogen fluoride solvent or by washing the amine hydrofluoride solvent with water.

23. A process according to claim 21 or 22, wherein the hydrogen halide recovered from the amine hydrohalide solvent is anhydrous or is in the form of an aqueous solution of hydrogen fluoride.

24. A process according to any one of claims 21 to 23, wherein after step (3) the amine hydrohalide solvent is recycled to the first step of the process.

25. A process according to any one of the preceding claims, wherein the amine hydrohalide is an amine hydrofluoride which acts as a catalyst for the fluorination of an organic compound.

26. A process according to claim 24, wherein the fluorination reaction and the separation step are carried out in a single reaction vessel.

27. A process according to claim 24, wherein the fluorination reaction and the separation step are carried out as parts of a multi-stage process.
